(19) United States
(12) Patent Application Publication
(10) Pub. No.: US 2026/0161247 A1
(43) Pub. Date: Jun. 11, 2026

(54) INPUT APPARATUS

(71) Applicant: Wacom Co., Ltd., Saitama (JP)

(72) Inventor: Tomohiro KAGAMI, Saitama (JP)

(21) Appl. No.: 19/181,274

(22) Filed: Apr. 16, 2025

Related U.S. Application Data
(63) Continuation of application No. PCT/JP2023/036754, filed on Oct. 10, 2023.

(30) Foreign Application Priority Data
Oct. 17, 2022 (JP) 2022-166281

(51) Int. Cl. G06F 3/041; G06F 3/044; G06F 3/046

(52) U.S. Cl. CPC G06F 3/04164; G06F 3/044; G06F 3/046; G06F 2203/04106; G06F 2203/04107; G06F 2203/04114

(57) ABSTRACT

Provided is an input apparatus including a sensor panel having a first position detection unit, in which the first position detection unit has a base portion, a plurality of sensor electrodes, and a plurality of wiring lines, the base portion has a first layer portion, a fold-back portion, and a second layer portion, the fold-back portion is connected to the first layer portion and the second layer portion, the first layer portion and the second layer portion are disposed to overlap with each other when the sensor panel is viewed in plan view, each of the sensor electrodes is disposed on the first layer portion, and each of the wiring lines is connected to a respective one of the sensor electrodes, and each of the wiring lines extends from the fold-back portion to the second layer portion.

### BACKGROUND

### Technical Field

The present disclosure relates to an input apparatus.

### Description of the Related Art

In Japanese Patent Laid-open No. 2021-33543, an input apparatus including a position detection unit configured to be capable of detecting an indicated position has been proposed. In Japanese Patent Laid-open No. 2021-33543, the position detection unit has a plurality of sensor electrodes formed of a conductor and wiring lines that are connected to each of the sensor electrodes and in which a detection signal flows. Further, the wiring lines are connected to a control board of the input apparatus after being routed to a place that is set in advance in the input apparatus.

### BRIEF SUMMARY

In the input apparatus, various configurations such as the position detection unit and the control board are mounted in an outer shell of the input apparatus. These configurations are disposed in a limited space in the outer shell of the input apparatus. Thus, depending on the arrangement position of these configurations, specifications of the input apparatus such as the width of the bezel of a tablet-type input apparatus are subject to restrictions in some cases.

The present disclosure is made in view of such circumstances and intends to enhance the flexibility of the arrangement of mounted configurations and suppress the occurrence of restrictions on specifications.

According to the present disclosure, an input apparatus with the following configuration is provided.
[1] An input apparatus including a sensor panel having a first position detection unit, in which the first position detection unit has a base portion, a plurality of sensor electrodes, and a plurality of wiring lines, the base portion has a first layer portion, a fold-back portion, and a second layer portion, the fold-back portion is connected to the first layer portion and the second layer portion, the first layer portion and the second layer portion are disposed to overlap with each other when the sensor panel is viewed in plan view, each of the sensor electrodes is disposed on the first layer portion, and each of the wiring lines is connected to a respective one of the sensor electrodes, and each of the wiring lines extends from the fold-back portion to the second layer portion.

According to the present disclosure, the second layer portion disposed to overlap with the first layer portion when the sensor panel is viewed in plan view is included. Thus, the flexibility of the arrangement of the mounted configurations is enhanced, and the occurrence of restrictions on specifications is suppressed.

Examples of various embodiments of the present disclosure are depicted below. The embodiments depicted below can be combined with each other.
[2] The input apparatus according to [1], in which the plurality of wiring lines have an aggregated-lines portion, the wiring lines extend to have a component of a direction orthogonal to a direction parallel to an extension direction of the sensor electrodes in the aggregated-lines portion, and the aggregated-lines portion is disposed on the second layer portion or the fold-back portion.
[3] The input apparatus according to [2], in which the second layer portion has a control board, the aggregated-lines portion and a controller are disposed on the control board, and the aggregated-lines portion is connected to the controller.
[4] The input apparatus according to [2], in which the second layer portion has a communication portion and a control board, the communication portion is a flexible substrate, and the aggregated-lines portion is disposed on the communication portion, a controller is disposed on the control board, and the aggregated-lines portion extending from the communication portion is connected to the controller.
[5] The input apparatus according to any one of [1] to [4], in which the first layer portion and the fold-back portion are formed of different components, and the fold-back portion is formed of a flexible substrate.
[6] The input apparatus according to [5], in which the base portion has a plurality of the fold-back portions that are independent, and each of the fold-back portions is connected to the first layer portion and the second layer portion by pressure bonding.
[7] The input apparatus according to [2], in which the second layer portion has a communication portion and a control board, the first layer portion, the fold-back portion, and the communication portion are formed of the same component, and the aggregated-lines portion is disposed on the fold-back portion or the communication portion.
[8] The input apparatus according to any one of [1] to [7], in which the sensor electrodes have a plurality of first sensor electrodes and a plurality of second sensor electrodes, and the plurality of wiring lines have a plurality of first wiring lines and a plurality of second wiring lines, each of the first sensor electrodes is disposed on a surface of the first layer portion on a first side, and each of the second sensor electrodes is disposed on a surface of the first layer portion on a second side, the first layer portion has an edge portion, both the fold-back portion and the second layer portion are disposed at the edge portion, and the first wiring lines or the second wiring lines extend to the fold-back portion and the second layer portion.
[9] The input apparatus according to [8], in which the first layer portion has a first edge portion and second edge portion as the edge portion, the first wiring lines extend to the fold-back portion and the second layer portion corresponding to the first edge portion, and the second wiring lines extend to the fold-back portion and the second layer portion corresponding to the second edge portion, and the second layer portion corresponding to the first edge portion does not overlap with the second layer portion corresponding to the second edge portion when the sensor panel is viewed in plan view.
[10] The input apparatus according to any one of [1] to [9], further including a shield portion, in which the sensor panel further has a second position detection unit, the first position detection unit is configured to detect a position by a capacitive coupling system, the second position detection unit is configured to be detect a position by an electromagnetic induction system, and has a plurality of sensor coils, and the first layer portion, the sensor coils of the second position detection unit, the shield portion, and the second layer portion are stacked in that order.
[11] An input apparatus including a sensor panel having a first position detection unit and a second position detection unit, in which the first position detection unit is configured to detect a position by a capacitive coupling system, and the first position detection unit has a base portion, a plurality of first sensor electrodes and a plurality of second sensor electrodes, and a plurality of first wiring lines and a plurality of second wiring lines, each of the first sensor electrodes is a receiving electrode extending in a first direction, and each of the second sensor electrodes is a transmitting electrode extending in a second direction intersecting the first direction, each of the first sensor electrodes and each of the first wiring lines are disposed on a surface of the base portion on a first side, and each of the second sensor electrodes and each of the second wiring lines are disposed on a surface of the base portion on a second side, each of the first wiring lines is connected to a respective one of the first sensor electrodes, and each of the second wiring lines is connected to a respective one of the second sensor electrodes, the plurality of first wiring lines have a first aggregated-lines portion, and the plurality of second wiring lines have a second aggregated-lines portion, the first wiring lines extend to have a component of a direction orthogonal to a direction parallel to the first direction in the first aggregated-lines portion, the second wiring lines extend to have a component of a direction orthogonal to a direction parallel to the second direction in the second aggregated-lines portion, the second position detection unit is configured to detect a position by an electromagnetic induction system, and the second position detection unit has a plurality of first sensor coils and a plurality of second sensor coils, each of the first sensor coils extends in the first direction, and each of the second sensor coils extends in the second direction, the plurality of first sensor coils have a first outside sensor coil disposed closest to the second aggregated-lines portion in the second direction, the plurality of second sensor coils have a second outside sensor coil disposed closest to the first aggregated-lines portion in the first direction, and at least one of (1) or (2) is satisfied. (1) an interval equal to or longer than 28 millimeters is set between the first aggregated-lines portion and the second outside sensor coil. (2) an interval equal to or longer than 28 millimeters is set between the second aggregated-lines portion and the first outside sensor coil.
[12] The input apparatus according to [11], in which, in a case in which the interval equal to or longer than 28 millimeters is set between the first aggregated-lines portion and the second outside sensor coil, the second outside sensor coil has an inside coil portion extending in the second direction and an outside coil portion that extends in the second direction and in which a current flows in an opposite direction to a direction of the current in the inside coil portion, and at least part of the first aggregated-lines portion is disposed to overlap with a center position between the inside coil portion and the outside coil portion when the sensor panel is viewed in plan view.
[13] An input apparatus including a sensor panel having a first position detection unit and a second position detection unit, and a chassis made of metal, in which the first position detection unit is configured to detect a position by a capacitive coupling system, and the first position detection unit has a base portion, a plurality of first sensor electrodes, a plurality of second sensor electrodes, a plurality of first wiring lines, and a plurality of second wiring lines, each of the first sensor electrodes is a receiving electrode extending in a first direction, and each of the second sensor electrodes is a transmitting electrode extending in a second direction intersecting the first direction, each of the first sensor electrodes and each of the first wiring lines are disposed on a surface of the base portion on a first side, and each of the second sensor electrodes and each of the second wiring lines are disposed on a surface of the base portion on a second side, each of the first wiring lines is connected to a respective one of the first sensor electrodes, and each of the second wiring lines is connected to a respective one of the second sensor electrodes, the plurality of first wiring lines have a first aggregated-lines portion, and the plurality of second wiring lines have a second aggregated-lines portion, the first wiring lines extend to have a component of a direction orthogonal to a direction parallel to the first direction in the first aggregated-lines portion, the second wiring lines extend to have a component of a direction orthogonal to a direction parallel to the second direction in the second aggregated-lines portion, the second position detection unit is configured to detect a position by an electromagnetic induction system, and the second position detection unit has a plurality of first sensor coils and a plurality of second sensor coils, each of the first sensor coils extends in the first direction, and each of the second sensor coils extends in the second direction, each of the first sensor coils and each of the second sensor coils are disposed inside the chassis, and at least one of the first aggregated-lines portion and the second aggregated-lines portion is disposed outside relative to the chassis when the sensor panel is viewed in plan view.
[14] An input apparatus including a sensor panel having a first position detection unit and a second position detection unit, in which the first position detection unit is configured to detect a position by a capacitive coupling system, and the first position detection unit has a base portion, a plurality of first sensor electrodes and a plurality of second sensor electrodes, and a plurality of wiring lines, each of the first sensor electrodes is a receiving electrode extending in a first direction, and each of the second sensor electrodes is a transmitting electrode extending in a second direction intersecting the first direction, each of the first sensor electrodes and each of the wiring lines are disposed on a surface of the base portion on a first side, and each of the second sensor electrodes is disposed on a surface of the base portion on a second side, each of the wiring lines is connected to a respective one of the first sensor electrodes, the plurality of wiring lines have an aggregated-lines portion, the wiring lines extend to have a component of a direction orthogonal to a direction parallel to the first direction in the aggregated-lines portion, the second position detection unit is configured to detect a position by an electromagnetic induction system, and the second position detection unit has a plurality of first sensor coils and a plurality of second sensor coils, each of the first sensor coils extends in the first direction, and each of the second sensor coils extends in the second direction, the plurality of second sensor coils have an outside sensor coil disposed closest to the aggregated-lines portion in the first direction, the outside sensor coil has an inside coil portion extending in the second direction and an outside coil portion extending in the second direction and in which a current flows in an opposite direction to a direction of the current in the inside coil portion, and at least part of the aggregated-lines portion is disposed to overlap with a center position between the inside coil portion and the outside coil portion when the sensor panel is viewed in plan view.
[15] The input apparatus according to [14], in which the whole of the aggregated-lines portion is disposed between the inside coil portion and the outside coil portion when the sensor panel is viewed in plan view.
[16] An input apparatus including a sensor panel having a first position detection unit and a second position detection unit, and a control board on which a controller is disposed, in which the first position detection unit is configured to detect a position by a capacitive coupling system, and the first position detection unit has a base portion, a plurality of first sensor electrodes, a plurality of second sensor electrodes, and a plurality of wiring lines, each of the first sensor electrodes is a receiving electrode extending in a first direction, and each of the second sensor electrodes is a transmitting electrode extending in a second direction intersecting the first direction, each of the first sensor electrodes and each of the wiring lines are disposed on a surface of the base portion on a first side, and each of the second sensor electrodes is disposed on a surface of the base portion on a second side, each of the wiring lines is connected to a respective one of the first sensor electrodes, the plurality of wiring lines have an aggregated-lines portion, the wiring lines extend to have a component of a direction orthogonal to a direction parallel to the first direction in the aggregated-lines portion, the controller, in operation, calculates the position based on a difference between signals flowing in the wiring lines forming the aggregated-lines portion, the second position detection unit is configured to detect a position by an electromagnetic induction system, and the second position detection unit has a plurality of first sensor coils and a plurality of second sensor coils, each of the first sensor coils extends in the first direction, and each of the second sensor coils extends in the second direction, the plurality of second sensor coils have an outside sensor coil disposed closest to the aggregated-lines portion in the first direction, the outside sensor coil has an inside coil portion extending in the second direction and an outside coil portion extending in the second direction and in which a current flows in an opposite direction to a direction of the current in the inside coil portion, and the aggregated-lines portion is disposed to overlap with one of the inside coil portion and the outside coil portion when the sensor panel is viewed in plan view.
[17] The input apparatus according to [16], in which the aggregated-lines portion is disposed to overlap with only one of the inside coil portion and the outside coil portion when the sensor panel is viewed in plan view.

### BRIEF DESCRIPTION OF THE SEVERAL VIEWS OF THE DRAWINGS

FIG. 1 is a perspective view of an input apparatus 100 according to a first embodiment;

FIG. 2 is an exploded perspective view of the input apparatus 100 depicted in FIG. 1;

FIG. 3A is an end view of the input apparatus 100 depicted in FIG. 1 along an x-z plane; and FIG. 3B is an enlarged view of a region B depicted in FIG. 3A;

FIG. 4 depicts a state in which a first layer portion 2A, fold-back portions 2B1 and 2B2, and communication portions 2C1 are 2C2 are developed into a planar shape. FIG. 4 depicts parts of receiving electrodes 3B and transmitting electrodes 3A and, although depiction is omitted, a large number of the receiving electrodes 3B are disposed to be arranged in an x direction and a large number of the transmitting electrodes 3A are disposed to be arranged in a y direction. Also, the receiving electrodes 3B disposed on the back surface of the first layer portion 2A are depicted by dashed lines in FIG. 4;

FIG. 5 is a perspective view of a sensor panel 101, a chassis 102, and an overall control board 22 as viewed from the bottom surface side;

FIG. 6 is a bottom view of the sensor panel 101, the chassis 102, and the overall control board 22;

FIG. 7 is a plan view of a coil substrate 12A;

FIG. 8 is a functional block diagram of the input apparatus 100;

FIG. 9 is a developed view for explaining the configuration of Modification 1 of the first embodiment;

FIG. 10 is a developed view for explaining the configuration of Modification 2 of the first embodiment;

FIG. 11A is a developed view for explaining the configuration of Modification 3 of the first embodiment. FIG. 11B is a developed view relating to Modification 3 having a different configuration from FIG. 11A;

FIG. 12A is an end view of the input apparatus 100 according to Modification 4 (input apparatus 100 that does not include a display device 21) along the x-z plane. FIG. 12B is an enlarged view of a region B depicted in FIG. 12A;

FIG. 13 is a developed view for explaining the configuration of Modification 5 of the first embodiment;

FIG. 14 is a developed view for explaining the configuration of Modification 6 of the first embodiment;

FIG. 15A and FIG. 15B are developed views for explaining the configuration of a second embodiment and depict a state in which the first layer portion 2A, the fold-back portions 2B1 and 2B2, and the communication portions 2C1 and 2C2 are developed into a planar shape. FIG. 15A schematically depicts the positional relation among the receiving electrodes 3B formed on the lower surface side of a base portion 2, x direction coils 13A, and the like. FIG. 15B schematically depicts the positional relation among the transmitting electrodes 3A formed on the upper surface side of the base portion 2, y direction coils 13B, and the like;

FIG. 16 is an end view along a y-z plane relating to an aggregated-lines portion 4b of wiring lines 4B depicted in FIG. 15A, and the like;

FIG. 17 is an end view along the y-z plane relating to the aggregated-lines portion 4b of the wiring lines 4B and the like, for explaining the configuration of a third embodiment;

FIG. 18 is a diagram depicting the positional relation of the aggregated-lines portion 4b of the wiring lines 4B and the like for explaining the configuration of a fourth embodiment;

FIG. 19 is a diagram depicting the positional relation of the aggregated-lines portion 4b of the wiring lines 4B and the like for explaining the configuration of a fifth embodiment; and

FIG. 20 depicts the level of electromagnetic noise applied to a measurement wiring line that imitates the aggregated-lines portion 4b and extends in parallel to the y direction in the case in which the measurement wiring line is disposed near the y direction coil 13B and scanning of the position of this measurement wiring line is executed in the x direction when a current is made to flow in the y direction coil 13B.

### DETAILED DESCRIPTION

Embodiments are described below on the basis of the drawings. Various characteristic matters depicted in the embodiments to be depicted below can be combined with each other. Further, an disclosure is independently established regarding each characteristic.

### 1 First Embodiment

### 1-1 Description of Configuration of First Embodiment

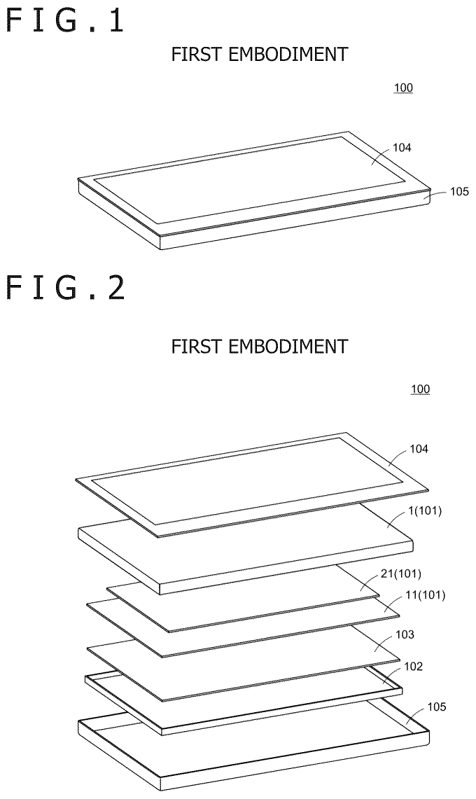

As depicted in FIG. 1, an input apparatus 100 according to a first embodiment is thin rectangular tablet-type electronic equipment. The input apparatus 100 is not limited to the tablet-type electronic equipment and may be equipment with a smaller size than the tablet-type electronic equipment (for example, smartphone), a personal computer having a position detection function in a display screen, or the like.

As depicted in FIG. 2, the input apparatus 100 includes a sensor panel 101, a chassis 102, a shield portion 103, a front member 104, and an outer shell 105.

In the following, for convenience of description, the stacking direction of the configurations of the sensor panel 101 is defined as an upward-downward direction or a z direction. Further, a plane parallel to the front member 104 is defined as a reference plane, and an x-y coordinate system is defined as a rectangular coordinate system of this reference plane.

### 1-1-1 Sensor Panel 101

As depicted in FIG. 2, the sensor panel 101 includes a first position detection unit 1 having a function of detecting the position of a human body (finger), a second position detection unit 11 having a function of detecting the position of an electronic pen, a display device 21 having a function of displaying an image, and an overall control board 22.

In the first embodiment, the first position detection unit 1 is configured to be capable of detecting the position by the capacitive coupling system, and the second position detection unit 11 is configured to be capable of detecting the position by the electromagnetic induction system. Moreover, in the first embodiment, a first layer portion 2A, sensor coils 13 of the second position detection unit 11, the shield portion 103, and a second layer portion 2C, which are described later, are disposed to be stacked in that order. The configuration of the sensor panel 101 is described in detail below.

### 1-1-1-1 First Position Detection Unit 1

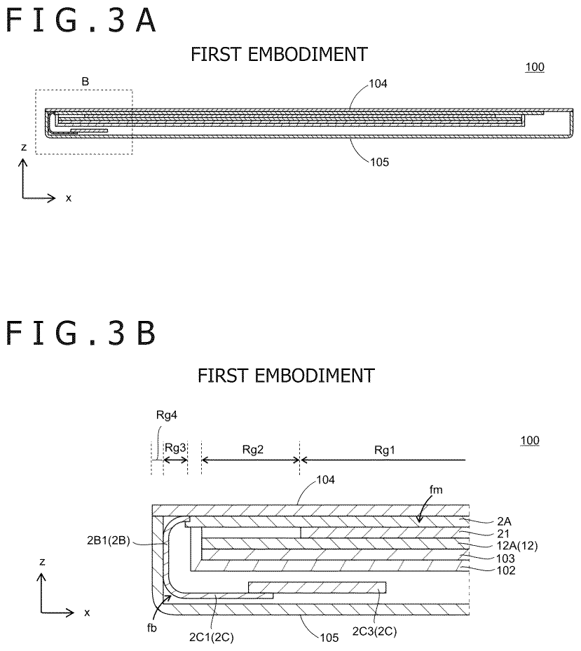

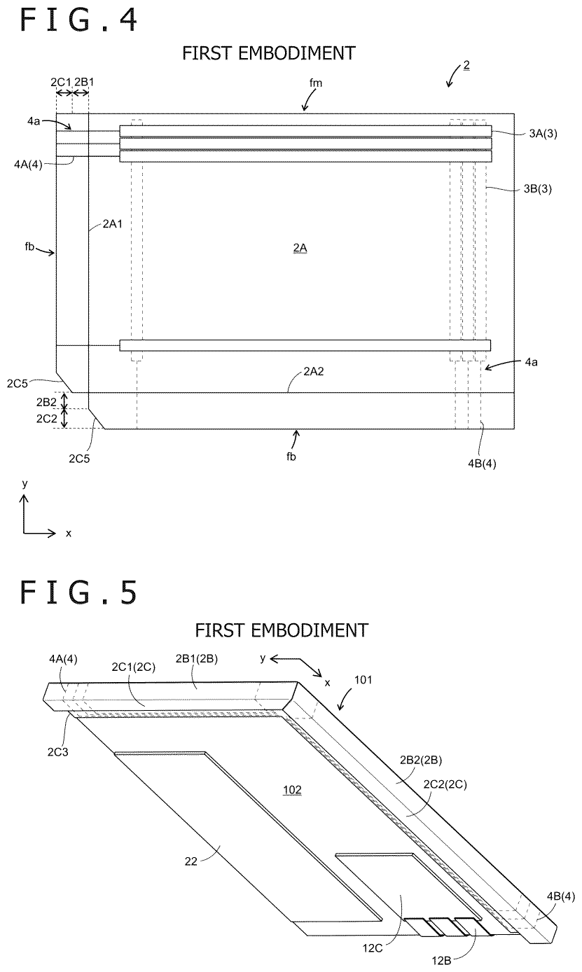

As depicted in FIGS. 3A to 4, the first position detection unit 1 includes a base portion 2, sensor electrodes 3 having transmitting electrodes 3A and receiving electrodes 3B, and wiring lines 4.

### Base Portion 2

As depicted in FIGS. 4 to 6, the base portion 2 includes the first layer portion 2A that is a film-shaped member fm, a fold-back portion 2B formed of one part of flexible substrates fb, and the second layer portion 2C having the other part of the flexible substrates fb. The flexible substrates fb forming the second layer portion 2C are connected to a control board 2C3 through, for example, a connector (depiction is omitted). The film-shaped member fm, the flexible substrates fb, and the control board 2C3 described here are formed of components different from each other.

### First Layer Portion 2A

As depicted in FIG. 4, the first layer portion 2A is formed of the film-shaped member fm, and the sensor electrodes 3 and the wiring lines 4 are disposed on the upper surface and the lower surface of the first layer portion 2A. For example, a lithography technique can be used as the method for forming the sensor electrodes 3 and the wiring lines 4. That is, the sensor electrodes 3 and the wiring lines 4 can be formed through patterning metal surfaces into a desired shape by removing part of the metal surfaces with a mask after forming the metal surfaces on the base portion 2.

The first layer portion 2A is disposed on the upper surface side (side of the front member 104) relative to the second layer portion 2C. The first layer portion 2A is disposed to overlap with the second layer portion 2C when the sensor panel 101 is viewed in plan view. Specifically, the second layer portion 2C is disposed inside relative to edge portions (outer edge portions) of the first layer portion 2A when the sensor panel 101 is viewed in plan view. The first layer portion 2A and the second layer portion 2C are disposed in parallel to each other, and the display device 21 is disposed between the first layer portion 2A and the second layer portion 2C.

As depicted in FIG. 4, the shape of the first layer portion 2A in plan view is a rectangular shape (in the embodiment, oblong) and has four edge portions. Specifically, the first layer portion 2A has one set of edge portions 2A1 and one set of edge portions 2A2. In the first embodiment, the edge portions 2A1 are shorter than the edge portions 2A2. However, the relation between the lengths of them may be inverse, or the lengths may be equal to each other. The edge portions 2A1 and the edge portions 2A2 can be defined as positions at which curving (bending) is started in the base portion 2.

One of the edge portion 2A1 and the edge portion 2A2 corresponds to the first edge portion, and the other corresponds to the second edge portion.

The transmitting electrodes 3A of the sensor electrodes 3 are disposed on the upper surface of the first layer portion 2A. The receiving electrodes 3B of the sensor electrodes 3 are disposed on the lower surface of the first layer portion 2A. The transmitting electrodes 3A may be disposed on the lower surface of the first layer portion 2A, and the receiving electrodes 3B may be disposed on the upper surface of the first layer portion 2A. Further, the wiring lines 4 connected to the sensor electrodes 3 (transmitting electrodes 3A and receiving electrodes 3B) are disposed on the first layer portion 2A. The wiring lines 4 extend over the first layer portion 2A, the fold-back portion 2B, and the second layer portion 2C.

### Fold-Back Portion 2B

The fold-back portion 2B depicted in FIGS. 4 and 5 is formed of part of the flexible substrates fb. The flexible substrates fb are thinner than the thickness of the film-shaped member fm forming the first layer portion 2A and thus are superior to the film-shaped member fm forming the first layer portion 2A in bendability. For example, the flexible substrates fb can be composed of polyimide, a liquid crystal polymer, or the like. The fold-back portion 2B (flexible substrates fb) can be joined to the first layer portion 2A (film-shaped member fm) by, for example, pressure bonding.

Here, for example, anisotropic conductive film (ACF) pressure bonding can be employed as the pressure bonding.

As depicted in FIGS. 3B to 5, the fold-back portion 2B is a bent portion in the base portion 2 and is connected to the first layer portion 2A and the second layer portion 2C. Specifically, an upper portion of the fold-back portion 2B is connected to the first layer portion 2A, and a lower portion of the fold-back portion 2B is connected to the second layer portion 2C. The fold-back portion 2B has fold-back portions 2B1 and 2B2 independent of each other. Specifically, the fold-back portion 2B1 is connected to the edge portion 2A1, and the fold-back portion 2B2 is connected to the edge portion 2A2. The fold-back portions 2B1 and 2B2 are separate from each other. Wiring lines 4A connected to the transmitting electrodes 3A are disposed on the fold-back portion 2B1. Wiring lines 4B connected to the receiving electrodes 3B are disposed on the fold-back portion 2B2.

The fold-back portions 2B1 and 2B2 extend in the z direction (stacking direction of the front member 104 and the first position detection unit 1). The sectional shape of the fold-back portion 2B1 parallel to the extension direction of the corresponding electrodes (transmitting electrodes 3A) may be, for example, a shape linearly extending in the z direction or a shape curving into an arc shape as a whole. The same applies to the fold-back portion 2B2.

### Second Layer Portion 2C

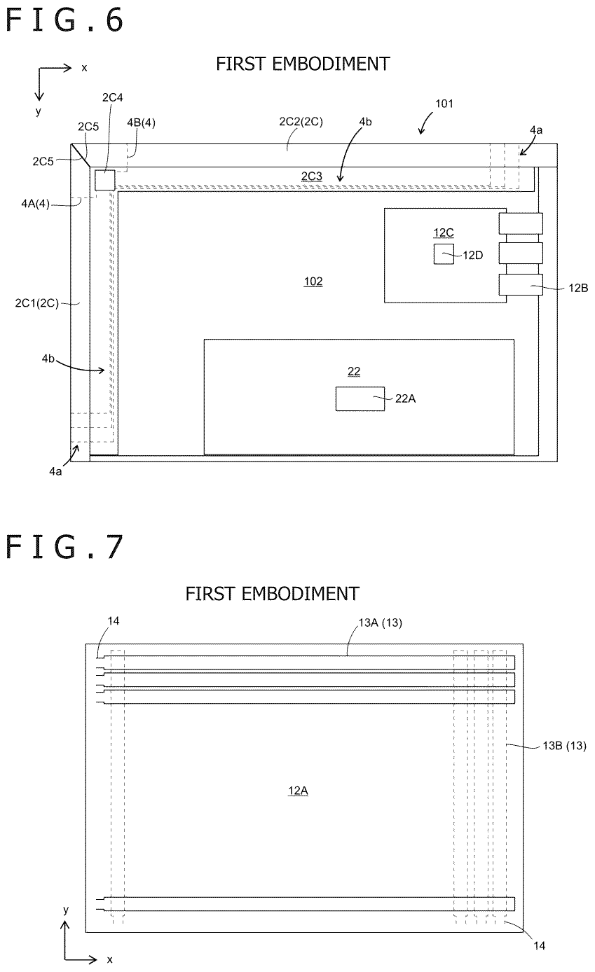

As depicted in FIGS. 5 and 6, the second layer portion 2C has communication portions 2C1 and 2C2 and the control board 2C3. The communication portion 2C1 is a portion that connects the fold-back portion 2B1 to the control board 2C3. The communication portion 2C2 is a portion that connects the fold-back portion 2B2 to the control board 2C3.

The communication portions 2C1 and 2C2 are the other part of the flexible substrates fb forming the fold-back portion 2B. For example, the control board 2C3 can be formed of a rigid substrate (substrate that does not have bendability). The communication portions 2C1 and 2C2 can be joined to the control board 2C3 through, for example, a connector (depiction is omitted).

On the control board 2C3 depicted in FIG. 6, for example, the wiring lines 4 and a controller 2C4 configured by an integrated circuit are disposed. The controller 2C4 includes a transmitting circuit and a receiving circuit for a transmission signal for detecting a touch by a finger. The transmitting circuit of the controller 2C4 is electrically connected to the transmitting electrodes 3A. Further, the receiving circuit of the controller 2C4 is electrically connected to the receiving electrodes 3B. As the transmission signal for detecting a touch by a finger, for example, a spreading code or the like can be employed. The transmission signal transmitted from the transmitting circuit of the controller 2C4 to the transmitting electrodes 3A is received by the receiving circuit of the controller 2C4 through the capacitance between the receiving electrode 3B and the transmitting electrode 3A and the receiving electrodes 3B. At a position touched by a finger, part of electric flux flowing from the transmitting electrode 3A toward the receiving electrode 3B is transferred from the transmitting electrode 3A to the finger, and thus the cross-capacitance decreases. Thus, the level of the received signal of the receiving electrode 3B corresponding to this touch position becomes low. The controller 2C4 detects this change in the received signal as a touch signal of the finger. The controller 2C4 outputs detected position information to an overall controller 22A of the overall control board 22. Aggregated-lines portions 4b of the wiring lines 4 to be described later are disposed on the control board 2C3 of the second layer portion 2C. In the example of the first embodiment, the shape of the control board 2C3 in plan view is a substantially L-shape. However, the shape of the control board 2C3 in plan view is not limited thereto and can be set to any shape.

When the sensor panel 101 is viewed in plan view, in the second layer portion 2C, the flexible substrate fb corresponding to (connected to) the edge portion 2A1 and the flexible substrate fb corresponding to (connected to) the edge portion 2A2 do not overlap with each other, and thus interference between the flexible substrates fb is avoided. Specifically, notches 2C5 (clearances) for avoiding the interference are formed at end portions of the communication portions 2C1 and 2C2. This keeps the flexible substrates fb from overlapping with each other when the flexible substrates fb are bent. In other words, in the state in which the flexible substrates fb are bent, the notch 2C5 of the communication portion 2C1 and the notch 2C5 of the communication portion 2C2 are separate from each other in the x-y plane.

### Sensor Electrode 3

The sensor electrodes 3 have a plurality of transmitting electrodes 3A extending in an x direction and a plurality of receiving electrodes 3B extending in a y direction. The transmitting electrodes 3A and the receiving electrodes 3B orthogonally intersect when the sensor panel 101 is viewed in plan view. The transmitting electrodes 3A and the receiving electrodes 3B are capacitively coupled through an insulating substrate (specifically, an insulating film or glass) at the intersection positions therebetween. The sensor electrodes 3 can be formed of transparent electrodes such that light of the display device 21 is transmitted through them. Further, the shape of the sensor electrodes 3 is not particularly limited. The sensor electrodes 3 may be formed into a mesh shape although being formed into a plate shape in the first embodiment.

### Wiring Line 4

As depicted in FIG. 4, the first position detection unit 1 includes a plurality of wiring lines 4. Each wiring line 4 is connected to a respective one of the sensor electrodes 3. Each wiring line 4 is disposed to extend over the first layer portion 2A, the fold-back portion 2B, and the second layer portion 2C. The plurality of wiring lines 4 have a plurality of wiring lines 4A connected to the transmitting electrodes 3A and a plurality of wiring lines 4B connected to the receiving electrodes 3B. Here, the plurality of wiring lines 4A can be defined in such a manner as to be classified into two parts described below. Specifically, as depicted in FIGS. 4 to 6, the plurality of wiring lines 4A have a non-aggregated-line portion 4a and the aggregated-lines portion 4b. Similarly, the plurality of wiring lines 4B also have the non-aggregated-line portion 4a and the aggregated-lines portion 4b.

### Non-Aggregated-Line Portion 4a

In the non-aggregated-line portions 4a, the wiring lines 4 linearly extend from the electrodes (transmitting electrodes 3A and receiving electrodes 3B).

First, a configuration is described regarding the wiring lines 4A. The wiring lines 4A extend in parallel to the x direction in the first layer portion 2A. Further, the wiring lines 4A extend in parallel to the z direction in the fold-back portion 2B1. Moreover, the wiring lines 4A extend in parallel to the x direction in the second layer portion 2C.

Next, a configuration is described regarding the wiring lines 4B. The wiring lines 4B extend in parallel to the y direction in the first layer portion 2A. Further, the wiring lines 4B extend in parallel to the z direction in the fold-back portion 2B2. Moreover, the wiring lines 4B extend in parallel to the y direction in the second layer portion 2C.

### Aggregated-Lines Portion 4b

In the aggregated-lines portions 4b, the wiring lines 4 extend to have a component of the direction orthogonal to the direction parallel to the extension direction of the electrodes (transmitting electrodes 3A and receiving electrodes 3B). In the first embodiment, the aggregated-lines portions 4b are disposed on the control board 2C3 in the second layer portion 2C.

The wiring lines 4A connected to the transmitting electrodes 3A extend to have a component of the y direction orthogonal to the x direction, which is the extension direction of the transmitting electrodes 3A, in the aggregated-lines portion 4b.

The wiring lines 4B connected to the receiving electrodes 3B extend to have a component of the x direction orthogonal to the y direction, which is the extension direction of the receiving electrodes 3B, in the aggregated-lines portion 4b.

The aggregated-lines portions 4b are parts at which the wiring lines 4 are aggregated. That is, the interval between the adjacent wiring lines 4 in the aggregated-lines portion 4b is shorter than the interval between the adjacent wiring lines 4 in the first layer portion 2A. That is, the interval between the wiring lines 4 in the aggregated-lines portion 4b among the wiring lines 4 is shorter than the interval between the wiring lines 4 at the portion in contact with the sensor electrodes (transmitting electrodes 3A and receiving electrodes 3B).

### 1-1-1-2 Second Position Detection Unit 11

As depicted in FIGS. 5 to 7, the second position detection unit 11 includes a substrate 12, the sensor coils 13, and wiring lines 14. The second position detection unit 11 is configured to be capable of detecting the position of an electronic pen for which depiction is omitted and the writing pressure of the electronic pen.

The electronic pen has a resonant circuit having a coil and a capacitor, a variable-capacitance capacitor in which the capacitance changes depending on the writing pressure of the electronic pen, and the like. Thus, in the first embodiment, the electronic pen does not need to include a battery.

### Substrate 12

As depicted in FIGS. 5 to 7, the substrate 12 includes a coil substrate 12A, a flexible substrate 12B, and a control board 12C.

The sensor coils 13 and the wiring lines 14 are disposed on the coil substrate 12A. The coil substrate 12A can be composed of, for example, a resin material such as a glass epoxy resin.

The flexible substrate 12B is connected to the coil substrate 12A and the control board 12C, and the wiring lines 14 are disposed on the flexible substrate 12B. The flexible substrate 12B is led out from a slit (not depicted) formed in the chassis 102 and extends to the control board 12C located as a lower layer.

The wiring lines 14 and a controller 12D configured by an integrated circuit are disposed on the control board 12C. An alternating current signal with the frequency equal to the resonant frequency of the resonant circuit of the electronic pen is transmitted from the controller 12D to the electronic pen through the sensor coils 13. The electronic pen makes electromagnetic induction coupling with the sensor coils 13. The resonant circuit of the electronic pen receives the alternating current signal from the sensor coils 13 and feeds back the received alternating current signal from the resonant circuit of the electronic pen to the sensor coils 13. The controller 12D receives the feedback signal from the electronic pen through the sensor coils 13. Further, the controller 12D can calculate the position of the pen tip of the electronic pen on the basis of the distribution of the level of the received signal according to a plurality of sensor coils 13.

Moreover, in the electronic pen, the capacitance of the variable-capacitance capacitor incorporated in the electronic pen changes depending on the writing pressure applied to the pen tip, and the frequency of the alternating current signal fed back to the sensor coils 13 changes. In the controller 12D, synchronous detection of the received alternating current signal is executed by a signal with the transmission frequency and change in the frequency (change in the phase) of the alternating current signal is detected. This can detect the writing pressure applied to the pen tip of the electronic pen.

### Sensor Coil 13

As depicted in FIG. 7, the sensor coils 13 have a plurality of x direction coils 13A extending in the x direction and a plurality of y direction coils 13B extending in the y direction. The extension direction of the x direction coils 13A and the extension direction of the y direction coils 13B orthogonally intersect when the sensor panel 101 is viewed in plan view. Although being schematically depicted in FIG. 7, the x direction coils 13A and the y direction coils 13B can be formed by being wound into a loop shape a plurality of times.

### Wiring Line 14

The second position detection unit 11 includes the plurality of wiring lines 14. Each wiring line 14 is connected to a respective one of the sensor coils 13. Each wiring line 14 is disposed to extend over the control board 12C through the coil substrate 12A and the flexible substrate 12B.

### 1-1-1-3 Display Device 21

The display device 21 depicted in FIGS. 2 and 3B can be configured by, for example, displays such as a liquid crystal display, an organic electroluminescence (EL) display, and electronic paper. In the display device 21, a large number of pixels are disposed in a matrix manner in the x direction and the y direction.

### 1-1-1-4 Overall Control Board 22

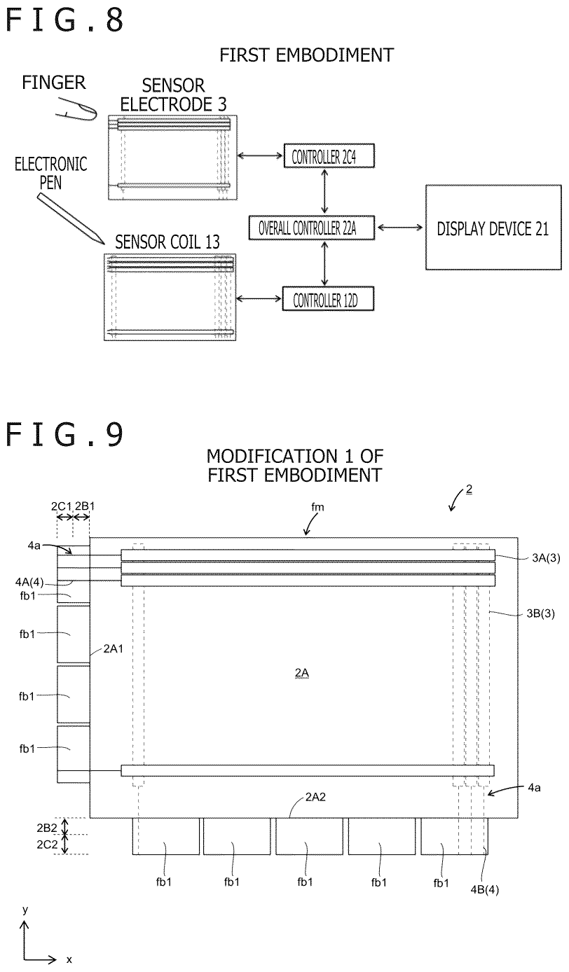

The overall controller 22A configured by, for example, a processor, a memory, and the like is disposed on the overall control board 22 depicted in FIGS. 5 and 6. As depicted in FIG. 8, the overall controller 22A is configured to be capable of executing control and power provision for various kinds of electronic equipment including the controller 2C4 of the first position detection unit 1, the controller 12D of the second position detection unit 11, and the display device 21.

Data of the first position detection unit 1 or the second position detection unit 11 is, for example, transmitted to a host (personal computer (PC)) through a communication section (for example, a universal serial bus (USB)). Then, in the host, various applications such as, for example, an application for rendering are executed and rendering processing based on the data of the first position detection unit 1 or the second position detection unit 11 is executed in these applications, so that display image data is generated. The display image data is output from the host to a display through a communication section (for example, a high-definition multimedia interface (HDMI) (registered trademark) or USB-C). In the embodiment, it has been explained that the host executes the various applications for rendering as described above. However, the configuration is not limited thereto and the input apparatus 100 itself (overall control board 22 itself) may be configured to be capable of executing these various applications.

### 1-1-2 Chassis 102

The chassis 102 depicted in FIGS. 2, 3B, 5, and 6 is a case disposed in the front member 104 and the outer shell 105. The first and second position detection units 1 and 11, the display device 21, and the shield portion 103 are disposed in the chassis 102. The chassis 102 can be composed of resin and also be composed of metal.

In the chassis 102, the display device 21, the coil substrate 12A of the second position detection unit 11, and the shield portion 103 are housed. Further, at a back surface portion of the chassis 102, the control board 2C3 of the first position detection unit 1, the control board 12C of the second position detection unit 11, and the overall control board 22 are disposed. For example, the control board 2C3, the control board 12C, and the overall control board 22 can be fixed to the back surface portion of the chassis 102 with the interposition of a spacer for which depiction is omitted.

In addition, the first layer portion 2A of the first position detection unit 1 is disposed on the upper side (front side) of the chassis 102. The fold-back portion 2B of the first position detection unit 1 is disposed on lateral sides of the chassis 102. The second layer portion 2C of the first position detection unit 1 is disposed on the back surface side of the chassis 102.

### 1-1-3 Shield Portion 103

The shield portion 103 depicted in FIGS. 2 and 3B is a plate-shaped member disposed directly under the sensor coils 13. The shield portion 103 suppresses mixing of an unnecessary signal (electromagnetic noise) into the electrodes and the like (sensor electrodes 3 and sensor coils 13) of the first and second position detection units 1 and 11, and suppresses the leakage of magnetic flux generated in the sensor coils 13 of the second position detection unit 11. Further, by suppressing the leakage of magnetic flux, change in characteristics of the sensor coils 13 due to a component under the sensor coils 13 can be avoided. For example, the shield portion 103 can be formed of a component obtained by applying an electromagnetic sheet for suppressing the leakage of magnetic flux generated in the sensor coils 13 to an electrically-conductive sheet for suppressing electromagnetic noise. For example, the electrically-conductive sheet can be composed of indium tin oxide (ITO), zinc oxide, tin oxide, or the like, and the electromagnetic sheet can be composed of a magnetic material.

In the first embodiment, the whole of the aggregated-lines portion 4b of the wiring lines 4A is disposed inside relative to the outer edge of the shield portion 103 when the sensor panel 101 is viewed in plan view. In addition, the aggregated-lines portion 4b of the wiring lines 4B is also similarly disposed inside relative to the outer edge of the shield portion 103.

### 1-1-4 Front Member 104 and Outer Shell 105

The front member 104 depicted in FIGS. 1 and 2 is, for example, a flat plate-shaped member composed of a transparent material such as glass or resin. A frame (not depicted) made of resin is disposed and bonded at the outer circumference of the front member 104. This frame engages with the outer shell 105 by a claw. This fixes the front member 104 to the outer shell 105. The front member 104 is joined to the outer shell 105 by, for example, an adhesive. Moreover, in the state in which the front member 104 is joined to the outer shell 105, an internal space that houses the first and second position detection units 1 and 11, the display device 21, the overall control board 22, the shield portion 103, and the like is formed between the front member 104 and the outer shell 105. The outer shell 105 is formed into a recessed shape such that the first and second position detection units 1 and 11 and the like can be housed, and can be composed of, for example, resin or the like.

As depicted in FIG. 3B, when the input apparatus 100 is viewed in plan view, the front member 104 can be divided into an active region Rg1, an edge region Rg2, an outside region Rg3, and a joined region Rg4.

The active region Rg1 is a rectangular region opposite to the pixels (depiction is omitted) arranged in a matrix manner in the display device 21. The sensor electrodes 3 are disposed in the active region Rg1. Thus, the position of a finger can be detected in the active region Rg1.

The edge region Rg2 is a region existing outside relative to the active region Rg1 and inside relative to the edge of the chassis 102. In the edge region Rg2, the sensor electrodes 3 are not disposed, but the sensor coils 13 are disposed. Due to this, it becomes easier to properly acquire the distribution of the level (level curve) of the received signal according to the plurality of sensor coils 13. Further, it is also possible to detect the tilt of the pen.

The outside region Rg3 is a region existing outside relative to the edge of the chassis 102 and inside relative to the joined region Rg4.

The joined region Rg4 is a region in which the frame that is disposed at the outer circumference of the front member 104 and is made of resin engages with the outer shell 105 by the claw.

### 1-2 Operation and Effects of First Embodiment

### 1-2-1 About Flexibility of Arrangement

The internal space between the front member 104 and the outer shell 105 is limited. In particular, in the totally thin configuration as in the first embodiment, this internal space is small, and restrictions are likely to occur on the arrangement position of various configurations such as wiring lines. The input apparatus 100 according to the first embodiment includes the second layer portion 2C disposed to overlap with the first layer portion 2A when the sensor panel 101 is viewed in plan view. Thus, the flexibility of the arrangement (the flexibility of the arrangement in the z direction) regarding the mounted configurations is enhanced. As a result, it is possible to suppress the occurrence of restrictions on specifications of the input apparatus 100. For example, the parts at which wiring lines are aggregated like the aggregated-lines portions 4b exist in the input apparatus 100. It is possible to implement specifications in which such parts are disposed not in the first layer portion 2A (edge region Rg2 and outside region Rg3) as an upper layer but in the second layer portion 2C as a lower layer.

### 1-2-2 About Suppression of Noise

A received signal of the sensor flows in the aggregated-lines portion 4b of the wiring lines 4B connected to the receiving electrodes 3B. Thus, superposition of electromagnetic noise on the receiving electrodes 3B is a cause of the lowering of the accuracy of position detection. Here, the aggregated-lines portion 4b of the wiring lines 4B extends to have a component of the x direction orthogonal to the y direction, which is the extension direction of the receiving electrodes 3B. Thus, if the aggregated-lines portion 4b of the wiring lines 4B is disposed in the first layer portion 2A (edge region Rg2 and outside region Rg3), the aggregated-lines portion 4b of the wiring lines 4B is disposed near the x direction coils 13A in parallel. In this case, the aggregated-lines portion 4b of the wiring lines 4B is affected by a magnetic field attributed to a current flowing in the x direction coils 13A, and electromagnetic noise becomes liable to be superimposed on the aggregated-lines portion 4b.

However, in the first embodiment, the whole of the aggregated-lines portion 4b of the wiring lines 4B is disposed inside relative to the outer edge of the shield portion 103 when the sensor panel 101 is viewed in plan view. In addition, across the shield portion 103, the x direction coils 13A are disposed on the upper side, and the aggregated-lines portion 4b of the wiring lines 4B is disposed on the lower side. Thus, the magnetic field generated by the flowing of a current in the x direction coils 13A is blocked by the shield portion 103, and superposition of electromagnetic noise on the received signal can be suppressed.

Further, the aggregated-lines portion 4b of the wiring lines 4A connected to the transmitting electrodes 3A also has a similar configuration. Thus, it is possible to suppress application of noise to the sensor coils 13 by a current (signal) flowing in the aggregated-lines portion 4b of the wiring lines 4A connected to the transmitting electrodes 3A of the first position detection unit 1.

### 1-3 Modifications of First Embodiment

### 1-3-1 Modification 1: Flexible Substrate fb Is Divided into Plurality of Portions

In the first embodiment, the flexible substrate fb forming the fold-back portion 2B1 and the communication portion 2C1 is formed of one piece of substrate. However, the flexible substrate fb is not limited thereto and may be divided into a plurality of portions. That is, as depicted in FIG. 9, the flexible substrate fb may be formed of a plurality of separated portions fb1. As a result, in Modification 1, the base portion 2 has independent multiple fold-back portions 2B1 and communication portions 2C1 (in the present modification, four portions 2B1 and four portions 2C1). In other words, when the sensor panel 101 is viewed in plan view, the fold-back portions 2B1 of the separated portions fb1 are separated (divided) from each other and the communication portions 2C1 of the separated portions fb1 are also separated (divided) from each other.

The flexible substrate fb forming the fold-back portion 2B2 and the communication portion 2C2 may also be separated (divided) into a plurality of portions similarly to the above description.

Due to the separation (division) of the flexible substrate fb into the plurality of portions in this manner, positional misalignment is less likely to occur when the flexible substrate fb is joined to the film-shaped member fm on which the sensor electrodes 3 are disposed and the control board 2C3.

### 1-3-2 Modification 2: First Example of Subject on which Aggregated-Lines Portion 4b is Disposed

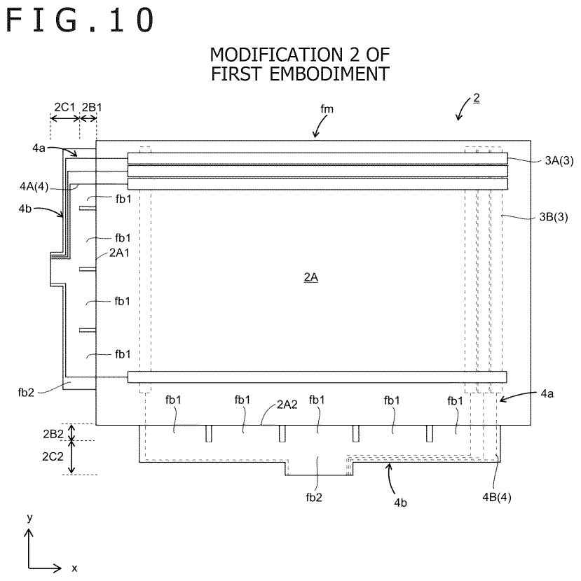

Although being disposed on the control board 2C3 in the first embodiment, the aggregated-lines portions 4b are not limited thereto and may be disposed on the flexible substrates fb. In the present Modification 2, as depicted in FIG. 10, the flexible substrates fb have a plurality of separated portions fb1 as in Modification 1 and a connection portion fb2 to which each separated portion fb1 is connected. In the present Modification 2, the aggregated-lines portions 4b are disposed on the connection portions fb2. The present Modification 2 can also achieve operation and effects similar to those of the first embodiment.

### 1-3-3 Modification 3: Second Example of Subject on which Aggregated-Lines Portion 4b is Disposed

In the first embodiment, the film-shaped member fm on which the sensor electrodes 3 are disposed is not bent, and bent portions are the flexible substrates fb. However, the configuration is not limited thereto. Although being inferior to the flexible substrate fb in bendability, the film-shaped member fm on which the sensor electrodes 3 are disposed has moderate elasticity and thus can be bent. Thus, the film-shaped member fm on which the sensor electrodes 3 are disposed may form the fold-back portions 2B1 and 2B2 and the communication portions 2C1 and 2C2. That is, in the present Modification 3, the first layer portion 2A, the fold-back portion 2B, and the communication portions 2C1 and 2C2 are formed of the same component (monolithic film-shaped member fm composed of the same material).

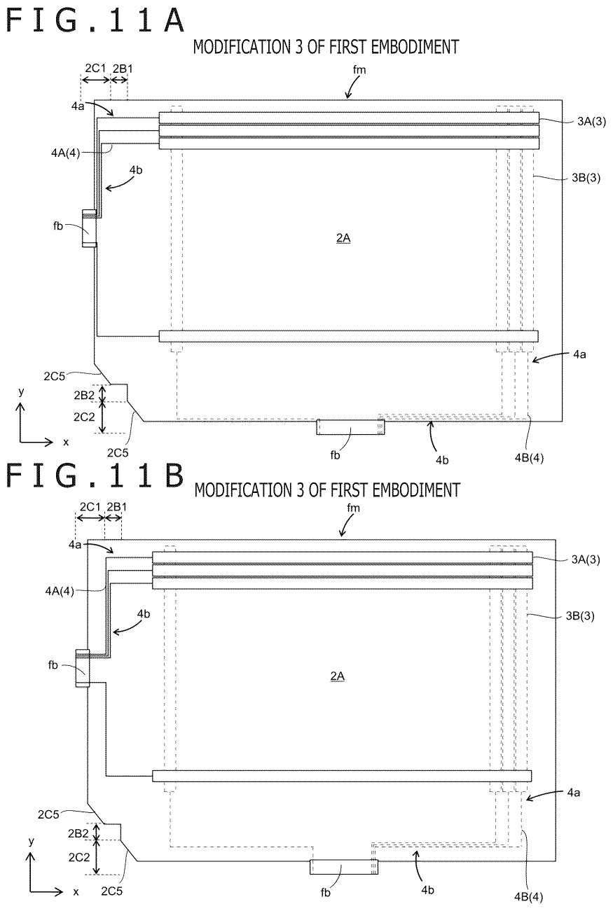

In the present Modification 3, as depicted in FIG. 11A, the aggregated-lines portions 4b may be disposed on the part of the second layer portion 2C in the film-shaped member fm. Alternatively, as depicted in FIG. 11B, the aggregated-lines portions 4b may be disposed on the part of the fold-back portion 2B in the film-shaped member fm.

Further, the film-shaped member fm on which the sensor electrodes 3 are disposed is more difficult to bent than the flexible substrate fb. Thus, it is preferable to keep the film-shaped member fm from being directly joined to the control board 2C3. That is, it is preferable to interpose the flexible substrate fb between the film-shaped member fm on which the sensor electrodes 3 are disposed and the control board 2C3 to allow the film-shaped member fm to have leeway.

### 1-3-4 Modification 4: Display Device 21 is Not Included

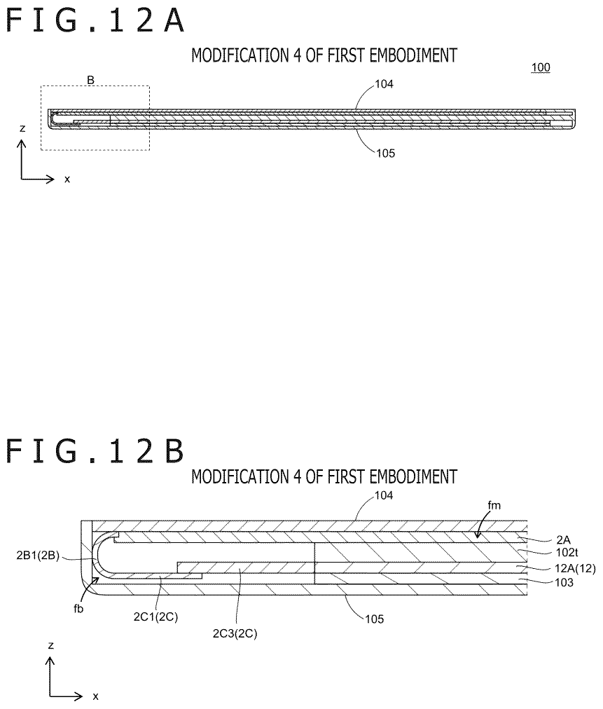

In the first embodiment, it has been explained that the input apparatus 100 includes the display device 21. However, the input apparatus 100 is not limited thereto. As depicted in FIGS. 12A and 12B, a form in which the input apparatus 100 does not include the display device 21 may be employed. A description is given of the present Modification 4 with focus on a part with a different configuration from the first embodiment, and the description is omitted as appropriate regarding a similar part.

The front member 104 of the input apparatus 100 can be composed of, for example, resin or the like and does not need to have transparency. The input apparatus 100 has a plate-shaped portion 102t disposed between the first layer portion 2A and the coil substrate 12A instead of the chassis 102. The plate-shaped portion 102t can be composed of resin, for example. The first layer portion 2A is disposed on the upper side of the plate-shaped portion 102t. The fold-back portion 2B is disposed on a lateral side of the plate-shaped portion 102t. The control board 2C3, the coil substrate 12A, and the control board 12C are disposed on the lower side of the plate-shaped portion 102t. Further, the shield portion 103 is disposed on the lower side of the coil substrate 12A. The present Modification 4 can also achieve operation and effects (flexibility of arrangement) similar to those of the first embodiment.

Moreover, the following form may be employed although being a different form from the form depicted in FIGS. 12A and 12B. All of the aggregated-lines portions 4b of the wiring lines 4A and the wiring lines 4B are disposed on the lower side relative to the shield portion 103 and inside relative to the outer edge of the shield portion 103 when the sensor panel 101 is viewed in plan view. This can achieve also the operation and effects relating to suppression of noise in the first embodiment.

### 1-3-5 Modification 5: Another Configuration of Aggregated-Lines Portion 4b

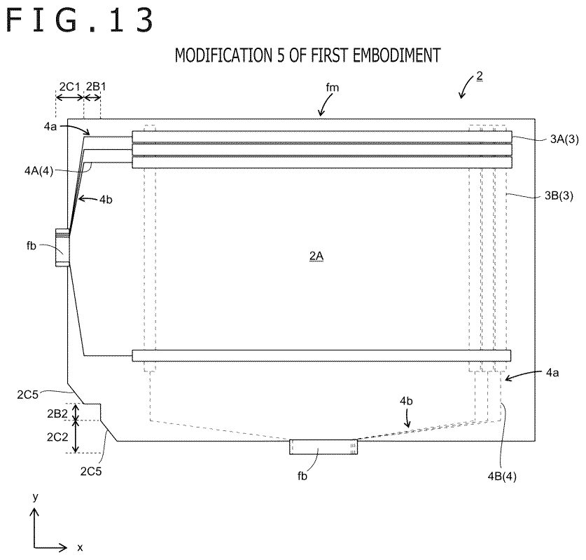

The wiring lines 4 in the first embodiment extend to have a component of the direction orthogonal to the direction parallel to the extension direction of the electrodes (transmitting electrodes 3A and receiving electrodes 3B) in the aggregated-lines portions 4b. Here, in the first embodiment, the plurality of wiring lines 4 have the form in which the wiring lines 4 are aggregated after the direction thereof is bent to form a right angle in the x-y plane in the aggregated-lines portion 4b. However, the plurality of wiring lines 4 are not limited thereto. As depicted in FIG. 13, the plurality of wiring lines 4 may be aggregated to extend in an oblique direction in the x-y plane in the aggregated-lines portions 4b.

### 1-3-6 Modification 6: Flexible Substrate fb Between Film-Shaped Members fm

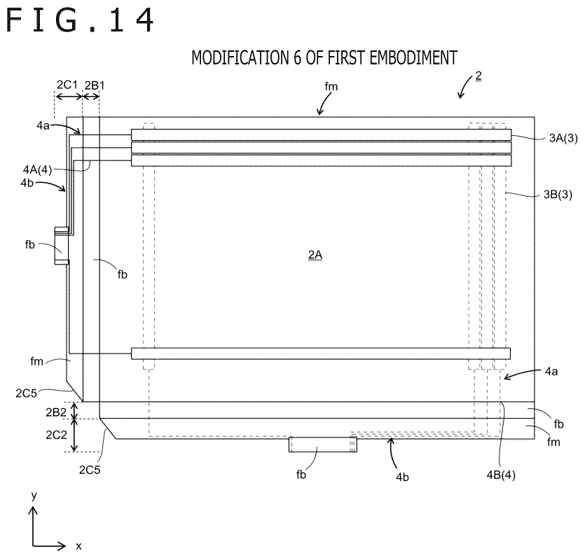

In the first embodiment, the form in which the film-shaped member fm is disposed only at the first layer portion 2A is employed. However, it is also possible to employ a form in which the film-shaped member fm is disposed at both the first layer portion 2A and the second layer portion 2C and the first layer portion 2A and the second layer portion 2C are connected by the flexible substrate fb. In Modification 6, as depicted in FIG. 14, the communication portions 2C1 and 2C2 forming part of the second layer portion 2C are formed of the film-shaped member fm similarly to the first layer portion 2A. The flexible substrate fb is superior to the film-shaped member fm in bendability. Thus, the flexible substrates fb form the fold-back portion 2B and the film-shaped members fm form the first layer portion 2A, and the second layer portion 2C.

### 2 Second Embodiment

### 2-1 Description of Configuration of Second Embodiment

In the configuration of a second embodiment, the basic configuration is common to the first embodiment. Thus, a different configuration is mainly described, and a description is omitted regarding the common configuration in some cases. The second embodiment includes a configuration for suppressing electromagnetic noise superimposed on the sensor electrodes 3.

In the following description, the correspondence relation of the respective configurations is as follows.

The receiving electrode 3B is one example of the first sensor electrode, and the transmitting electrode 3A is one example of the second sensor electrode.

Further, the extension direction of the receiving electrode 3B (y direction) is one example of the first direction, and the extension direction of the transmitting electrode 3A (x direction) is one example of the second direction.

Moreover, the wiring line 4B connected to the receiving electrode 3B is one example of the first wiring line, and the wiring line 4A connected to the transmitting electrode 3A is one example of the second wiring line.

In addition, the aggregated-lines portion 4b of the wiring lines 4B is one example of the first aggregated-lines portion, and the aggregated-lines portion 4b of the wiring lines 4A is one example of the second aggregated-lines portion.

Further, the y direction coil 13B is one example of the first sensor coil, and the x direction coil 13A is one example of the second sensor coil.

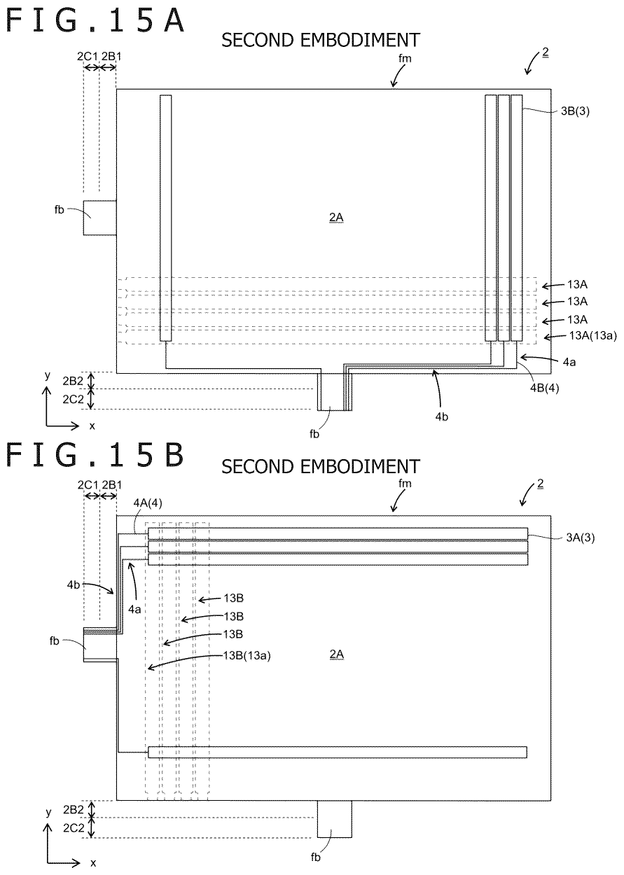

Moreover, an outside sensor coil 13a (see FIG. 15B) of the y direction coils 13B is one example of the first outside sensor coil, and the outside sensor coil 13a (see FIG. 15A) of the x direction coils 13A is one example of the second outside sensor coil.

The sensor electrodes 3 have the transmitting electrodes 3A and the receiving electrodes 3B similarly to the first embodiment. Further, the wiring lines 4A are connected to the transmitting electrodes 3A and have the aggregated-lines portion 4b. Moreover, the wiring lines 4B are connected to the receiving electrodes 3B and have the aggregated-lines portion 4b.

Similarly to the first embodiment, the sensor coils 13 have the x direction coils 13A depicted in FIG. 15A and the y direction coils 13B depicted in FIG. 15B.

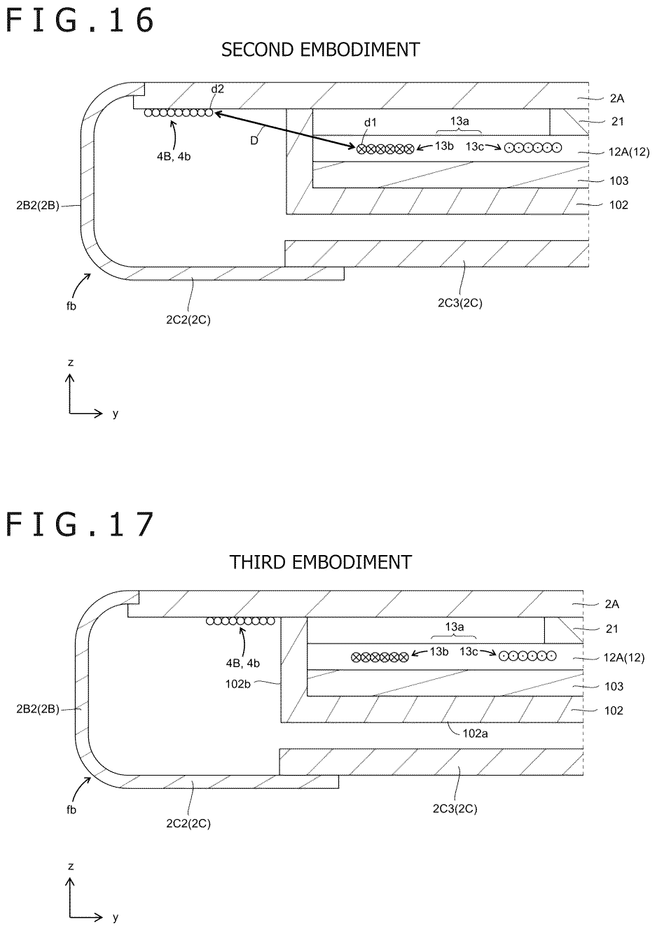

The plurality of x direction coils 13A extending in the x direction are disposed such that the plurality of x direction coils 13A are arranged in the y direction. Here, in the second embodiment, each x direction coil 13A is formed by being wound into a loop shape a plurality of times (in an example of FIG. 16, six turns). The same applies to each y direction coil 13B. Further, as depicted in FIG. 15A, the plurality of x direction coils 13A include the outside sensor coil 13a disposed closest to the aggregated-lines portion 4b in the y direction.

As depicted in FIG. 16, the outside sensor coil 13a of the x direction coils 13A has an outside coil portion 13b and an inside coil portion 13c extending in parallel to the x direction. Here, it is assumed that, in the plane of paper of FIG. 16, a current flows from the near side toward the far side in the outside coil portion 13b and the current flows from the far side toward the near side in the inside coil portion 13c. That is, the directions in which the current flows in the outside coil portion 13b and the inside coil portion 13c are opposite to each other.

In the second embodiment, an interval corresponding to a linear distance D is set between the outside sensor coil 13a of the x direction coils 13A and the aggregated-lines portion 4b of the wiring lines 4B connected to the receiving electrodes 3B. Here, the linear distance D is equal to or longer than 28 mm.

The linear distance D can be defined as the distance between a wiring line d1 closest to the aggregated-lines portion 4b in the y direction in the outside coil portion 13b and a wiring line d2 closest to the outside coil portion 13b in the y direction in the aggregated-lines portion 4b. As the distance between the wiring line d1 and the wiring line d2, a plurality of distances can be defined depending on the position of the wiring lines d1 and d2. The shortest distance among the distances between the wiring line d1 and the wiring line d2 is employed as the linear distance D.

### 2-2 Operation and Effects of Second Embodiment

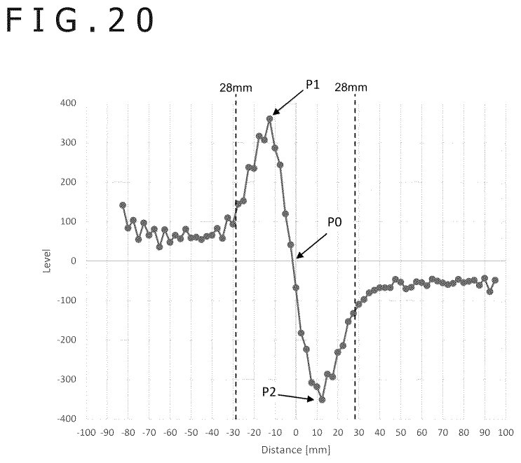

FIG. 20 depicts the level of electromagnetic noise applied to a measurement wiring line (measurement copper tape) that imitates the aggregated-lines portion 4b and extends in parallel to the y direction in the case in which the measurement wiring line is disposed near the y direction coil 13B and scanning of the position of this measurement wiring line is executed in the x direction when a current is made to flow in the y direction coil 13B. In FIG. 20, the position of the measurement wiring line is disposed at a height position substantially equivalent to that of the sensor electrodes 3 (receiving electrodes 3B). Further, the scanning of the position of the measurement wiring line is executed in the x direction, and the distance between the measurement wiring line and the y direction coil 13B is changed.

An arrow P0 in FIG. 20 corresponds to the level of the electromagnetic noise when the position of the measurement wiring line is located at the center position between the inside coil portion 13c and the outside coil portion 13b.

An arrow P1 in FIG. 20 corresponds to the level of the electromagnetic noise when the position of the measurement wiring line is located at the center position of the width in the x direction in the outside coil portion 13b.

An arrow P2 in FIG. 20 corresponds to the level of the electromagnetic noise when the position of the measurement wiring line is located at the center position of the width in the x direction in the inside coil portion 13c.

As depicted in FIG. 20, it turns out that the electromagnetic noise is suppressed when the linear distance between the position of the measurement wiring line and the y direction coil 13B is equal to or longer than 28 mm. The measurement result of FIG. 20 can be applied also to the relation between the x direction coil 13A and the aggregated-lines portion 4b of the wiring lines 4B of the receiving electrodes 3B extending in parallel to the x direction coil 13A. That is, in the second embodiment, the linear distance D between the outside sensor coil 13a of the x direction coil 13A and the aggregated-lines portion 4b of the wiring lines 4B of the receiving electrodes 3B is set equal to or longer than 28 mm on the basis of this measurement result of FIG. 20. In the second embodiment, superposition of electromagnetic noise on the received signal can be suppressed by employing such a configuration.

In the second embodiment, the configuration to suppress electromagnetic noise on the wiring lines 4B connected to the receiving electrodes 3B has been described. However, the configuration is not limited thereto. That is, the linear distance between the outside sensor coil 13a in the y direction coils 13B and the aggregated-lines portion 4b of the wiring lines 4A may be equal to or longer than 28 mm. This can suppress application of noise to the sensor coils 13 by a current (signal) flowing in the aggregated-lines portion 4b of the wiring lines 4A connected to the transmitting electrodes 3A of the first position detection unit 1.

Further, as described in Modification 4 of the first embodiment, a form in which the input apparatus 100 does not include the display device 21 is employed also in the second embodiment. Such a form can also achieve operation and effects similar to those of the above-described second embodiment.

In the second embodiment, the description has been given on the premise that the following Configuration (1) is satisfied. However, only Configuration (2) may be satisfied instead of Configuration (1), or both Configuration (1) and Configuration (2) may be satisfied.
Configuration (1): the linear distance between the outside sensor coil 13a in the x direction coils 13A and the aggregated-lines portion 4b of the wiring lines 4B connected to the receiving electrodes 3B is equal to or longer than 28 mm.
Configuration (2): the linear distance between the outside sensor coil 13a in the y direction coils 13B and the aggregated-lines portion 4b of the wiring lines 4A connected to the transmitting electrodes 3A is equal to or longer than 28 mm.

### 3 Third Embodiment

### 3-1 Description of Configuration of Third Embodiment

In the configuration of a third embodiment, the basic configuration is common to the first embodiment. Thus, a different configuration is mainly described, and a description is omitted regarding the common configuration in some cases. The third embodiment also includes a configuration for suppressing electromagnetic noise superimposed on the sensor electrodes 3 similarly to the second embodiment.

In the third embodiment, the chassis 102 is made of a metal and is formed of a component that readily blocks electromagnetic noise. For example, the chassis 102 can be composed of Steel Special Use Stainless (SUS) or aluminum. As depicted in FIG. 17, the chassis 102 has a bottom portion 102a and a wall portion 102b extending upward from the bottom portion 102a. The shield portion 103 is disposed on the bottom portion 102a. The display device 21, the coil substrate 12A, and the shield portion 103 are disposed inside the wall portion 102b. In addition, the first layer portion 2A is disposed on the wall portion 102b.

As depicted in FIG. 17, the coil substrate 12A (sensor coils 13) is disposed inside the chassis 102. Further, the aggregated-lines portion 4b of the wiring lines 4B connected to the receiving electrodes 3B is disposed outside relative to the chassis 102 when the sensor panel 101 is viewed in plan view. In other words, the aggregated-lines portion 4b of the wiring lines 4B is disposed outside relative to the wall portion 102b of the chassis 102.

### 3-2 Operation and Effects of Third Embodiment

The third embodiment can suppress superposition of electromagnetic noise on the received signal by employing the above-described configuration.

In the third embodiment, the configuration to suppress electromagnetic noise on the wiring lines 4B connected to the receiving electrodes 3B has been described. However, the configuration is not limited thereto. That is, the aggregated-lines portion 4b of the wiring lines 4A connected to the transmitting electrodes 3A may be disposed outside relative to the chassis 102 when the sensor panel 101 is viewed in plan view. This can suppress application of noise to the sensor coils 13 by a current (signal) flowing in the aggregated-lines portion 4b of the wiring lines 4A connected to the transmitting electrodes 3A of the first position detection unit 1.

In the third embodiment, the description has been given on the premise that the following Configuration (1) is satisfied. However, only Configuration (2) may be satisfied instead of Configuration (1), or both Configuration (1) and Configuration (2) may be satisfied.
Configuration (1): the aggregated-lines portion 4b of the wiring lines 4B connected to the receiving electrodes 3B is disposed outside relative to the chassis 102 when the sensor panel 101 is viewed in plan view.
Configuration (2): the aggregated-lines portion 4b of the wiring lines 4A connected to the transmitting electrodes 3A is disposed outside relative to the chassis 102 when the sensor panel 101 is viewed in plan view.

### 4 Fourth Embodiment

### 4-1 Description of Configuration of Fourth Embodiment

In the configuration of a fourth embodiment, the basic configuration is common to the first embodiment. Thus, a different configuration is mainly described, and a description is omitted regarding the common configuration in some cases. The fourth embodiment also includes a configuration for suppressing electromagnetic noise superimposed on the sensor electrodes 3 similarly to the second embodiment.

As depicted in FIG. 20, the arrow P0 corresponds to electromagnetic noise when the position of the measurement wiring line is located at the center position between the inside coil portion 13c and the outside coil portion 13b. Here, the electromagnetic noise is suppressed to low noise at the position of the arrow P0. This is because, although the difference in the magnetic field between the left and right wiring lines (inside coil portion 13c and outside coil portion 13b) generates an electromotive force, the difference in the magnetic field is small and thus the electromotive force is small on the upper side of the center position between the coils.

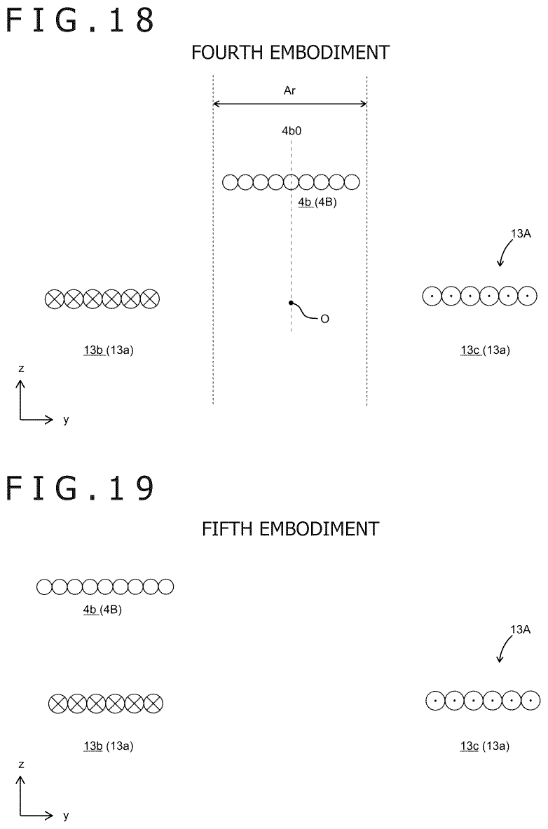

Thus, in the fourth embodiment, as depicted in FIG. 18, the position of the aggregated-lines portion 4b of the wiring lines 4B of the receiving electrodes 3B is set to a center position O between the outside coil portion 13b and the inside coil portion 13c in the y direction. More specifically, a center position 4b0 of the aggregated-lines portion 4b in the y direction is made to correspond with the center position O. The center position 4b0 does not have to completely correspond with the center position O. That is, it is preferable that at least part of the aggregated-lines portion 4b be disposed to overlap with the center position O when the sensor panel 101 is viewed in plan view.

Further, it is preferable that the whole of the aggregated-lines portion 4b fall within a predefined range Ar. For example, the predefined range Ar is a range between a position separate from the center position O by 5 mm in the +y direction and a position separate from the center position O by 5 mm in the −y direction. Due to the falling of the aggregated-lines portion 4b within this predefined range Ar, the electromagnetic noise is suppressed to a level substantially equivalent to the level of the electromagnetic noise in the second embodiment.

### 4-2 Operation and Effects of Fourth Embodiment

The fourth embodiment can suppress superposition of electromagnetic noise on the received signal by employing the above-described configuration. The fourth embodiment may be applied to the aggregated-lines portion 4b of the wiring lines 4A connected to the transmitting electrodes 3A. Moreover, synergistic effects can be expected when the fourth embodiment is combined with the above-described second embodiment. That is, with satisfaction of the configuration of the fourth embodiment, the linear distance D may be equal to or longer than 28 mm as described in the second embodiment.

### Fifth Embodiment

### 5-1 Description of Configuration of Fifth Embodiment

In the configuration of a fifth embodiment, the basic configuration is common to the first embodiment. Thus, a different configuration is mainly described, and a description is omitted regarding the common configuration in some cases. The fifth embodiment has a function of suppressing the lowering of the detection accuracy of the position although noise itself is superimposed on the aggregated-lines portion 4b.

In FIG. 20, the arrow P1 corresponds to the level of electromagnetic noise when the position of the measurement wiring line is located at the center position of the width in the x direction in the outside coil portion 13b. The arrow P2 corresponds to the level of the electromagnetic noise when the position of the measurement wiring line is located at the center position of the width in the x direction in the inside coil portion 13c. At these positions, the level of the electromagnetic noise is considerably high. On the other hand, variation in the level of the electromagnetic noise with respect to change in the distance in the x direction is small compared with the variation at the position of the arrow P0. That is, at the positions of the arrow P1 and the arrow P2, the value of the electromagnetic noise superimposed on the wiring lines is higher than the value of the electromagnetic noise at the position of the arrow P0. However, at the positions of the arrow P1 and the arrow P2, the value of the electromagnetic noise superimposed on the wiring lines readily falls within a predetermined range.

The measurement result of FIG. 20 can be applied also to the relation between the x direction coil 13A and the aggregated-lines portion 4b of the wiring lines 4B of the receiving electrodes 3B extending in parallel to the x direction coil 13A.

Thus, in the fifth embodiment, the aggregated-lines portion 4b is disposed to overlap with one of the outside coil portion 13b and the inside coil portion 13c of the x direction coil 13A when the sensor panel 101 is viewed in plan view. In the fifth embodiment, as depicted in FIG. 19, the aggregated-lines portion 4b is disposed to overlap with the outside coil portion 13b. In addition, in the fifth embodiment, the controller 2C4 is configured to calculate the position of a finger on the basis of the difference between signals flowing in the wiring lines 4B forming the aggregated-lines portion 4b. Specifically, the controller 2C4 includes a differential circuit that calculates the difference between the signals flowing in the wiring lines 4B. For example, the controller 2C4 can remove a signal attributed to electromagnetic noise superimposed on the wiring lines 4B by calculating the difference between the signals flowing in the adjacent wiring lines 4B.

The aggregated-lines portion 4b may be disposed to overlap with the inside coil portion 13c. Alternatively, the aggregated-lines portion 4b may be disposed to overlap with both the outside coil portion 13b and the inside coil portion 13c.

### 5-2 Operation and Effects of Fifth Embodiment

The fifth embodiment can suppress the lowering of the detection accuracy of the position because the aggregated-lines portion 4b satisfies the above-described positional relation with respect to the sensor coils 13 and the controller 2C4 includes the differential circuit. The fifth embodiment may be applied to the aggregated-lines portion 4b of the wiring lines 4A connected to the transmitting electrodes 3A.

The present disclosure is not limited to the preferred embodiments discussed above and may be implemented in diverse modifications so far as they are within the scope of this disclosure.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. An input apparatus comprising:
a sensor panel having a first position detection unit, wherein:
the first position detection unit has a base portion, a plurality of sensor electrodes, and a plurality of wiring lines,
the base portion has a first layer portion, a fold-back portion, and a second layer portion,
the fold-back portion is connected to the first layer portion and the second layer portion,
the first layer portion and the second layer portion are disposed to overlap with each other when the sensor panel is viewed in plan view,
each of the sensor electrodes is disposed on the first layer portion, and
each of the wiring lines is connected to a respective one of the sensor electrodes, and each of the wiring lines extends from the fold-back portion to the second layer portion.

2. The input apparatus according to claim 1, wherein:
the plurality of wiring lines have an aggregated-lines portion,
the wiring lines extend to have a component of a direction orthogonal to a direction parallel to an extension direction of the sensor electrodes in the aggregated-lines portion, and
the aggregated-lines portion is disposed on the second layer portion or the fold-back portion.

3. The input apparatus according to claim 2, wherein:
the second layer portion has a control board,
the aggregated-lines portion and a controller are disposed on the control board, and
the aggregated-lines portion is connected to the controller.

4. The input apparatus according to claim 2, wherein:
the second layer portion has a communication portion and a control board,
the communication portion is a flexible substrate, and the aggregated-lines portion is disposed on the communication portion,
a controller is disposed on the control board, and
the aggregated-lines portion extending from the communication portion is connected to the controller.

5. The input apparatus according to claim 1, wherein:
the first layer portion and the fold-back portion are formed of different components, and
the fold-back portion is formed of a flexible substrate.

6. The input apparatus according to claim 5, wherein:
the base portion has a plurality of the fold-back portions that are independent, and each of the fold-back portions is connected to the first layer portion and the second layer portion by pressure bonding.

7. The input apparatus according to claim 2, wherein:
the second layer portion has a communication portion and a control board,
the first layer portion, the fold-back portion, and the communication portion are formed of a same component, and
the aggregated-lines portion is disposed on the fold-back portion or the communication portion.

8. The input apparatus according to claim 1, wherein:
the sensor electrodes have a plurality of first sensor electrodes and a plurality of second sensor electrodes, and the plurality of wiring lines have a plurality of first wiring lines and a plurality of second wiring lines,
each of the first sensor electrodes is disposed on a surface of the first layer portion on first side, and each of the second sensor electrodes is disposed on a surface of the first layer portion on a second side,
the first layer portion has an edge portion,
both the fold-back portion and the second layer portion are disposed at the edge portion, and
the first wiring lines or the second wiring lines extend to the fold-back portion and the second layer portion.

9. The input apparatus according to claim 8, wherein:
the first layer portion has a first edge portion and a second edge portion as the edge portion,
the first wiring lines extend to the fold-back portion and the second layer portion corresponding to the first edge portion, and the second wiring lines extend to the fold-back portion and the second layer portion corresponding to the second edge portion, and
the second layer portion corresponding to the first edge portion does not overlap with the second layer portion corresponding to the second edge portion when the sensor panel is viewed in plan view.

10. The input apparatus according to claim 1, further comprising:
a shield portion, wherein:
the sensor panel further has a second position detection unit,
the first position detection unit is configured to detect a position by a capacitive coupling system,
the second position detection unit is configured to detect a position by an electromagnetic induction system, and has a plurality of sensor coils, and
the first layer portion, the sensor coils of the second position detection unit, the shield portion, and the second layer portion are stacked in that order.

11. An input apparatus comprising:
a sensor panel having a first position detection unit and a second position detection unit, wherein:
the first position detection unit is configured to detect a position by a capacitive coupling system, and the first position detection unit has a base portion, a plurality of first sensor electrodes, a plurality of second sensor electrodes, a plurality of first wiring lines and a plurality of second wiring lines,
each of the first sensor electrodes is a receiving electrode extending in a first direction, and each of the second sensor electrodes is a transmitting electrode extending in a second direction intersecting the first direction,
each of the first sensor electrodes and each of the first wiring lines are disposed on a surface of the base portion on a first side, and each of the second sensor electrodes and each of the second wiring lines are disposed on a surface of the base portion on a second side,
each of the first wiring lines is connected to a respective one of the first sensor electrodes, and each of the second wiring lines is connected to a respective one of the second sensor electrodes,
the plurality of first wiring lines have a first aggregated-lines portion, and the plurality of second wiring lines have a second aggregated-lines portion,
the first wiring lines extend to have a component of a direction orthogonal to a direction parallel to the first direction in the first aggregated-lines portion,
the second wiring lines extend to have a component of a direction orthogonal to a direction parallel to the second direction in the second aggregated-lines portion,
the second position detection unit is configured to detect a position by an electromagnetic induction system, and the second position detection unit has a plurality of first sensor coils and a plurality of second sensor coils,
each of the first sensor coils extends in the first direction, and each of the second sensor coils extends in the second direction,
the plurality of first sensor coils have a first outside sensor coil disposed closest to the second aggregated-lines portion in the second direction,
the plurality of second sensor coils have a second outside sensor coil disposed closest to the first aggregated-lines portion in the first direction, and
at least one of (1) or (2) is satisfied:
(1) an interval equal to or longer than 28 millimeters is set between the first aggregated-lines portion and the second outside sensor coil, or
(2) an interval equal to or longer than 28 millimeters is set between the second aggregated-lines portion and the first outside sensor coil.

12. The input apparatus according to claim 11, wherein,
in a case in which the interval equal to or longer than 28 millimeters is set between the first aggregated-lines portion and the second outside sensor coil,
the second outside sensor coil has an inside coil portion extending in the second direction and an outside coil portion that extends in the second direction and in which a current flows in an opposite direction to a direction of the current in the inside coil portion, and
at least part of the first aggregated-lines portion is disposed to overlap with a center position between the inside coil portion and the outside coil portion when the sensor panel is viewed in plan view.

13. An input apparatus comprising:
a sensor panel having a first position detection unit and a second position detection unit; and
a chassis made of metal, wherein:
the first position detection unit is configured to detect a position by a capacitive coupling system, and the first position detection unit has a base portion, a plurality of first sensor electrodes, a plurality of second sensor electrodes, a plurality of first wiring lines, and a plurality of second wiring lines,
each of the first sensor electrodes is a receiving electrode extending in a first direction, and each of the second sensor electrodes is a transmitting electrode extending in a second direction intersecting the first direction,
each of the first sensor electrodes and each of the first wiring lines are disposed on a surface of the base portion on a first side, and each of the second sensor electrodes and each of the second wiring lines are disposed on a surface of the base portion on the a second side,
each of the first wiring lines is connected to a respective one of the first sensor electrodes, and each of the second wiring lines is connected to a respective one of the second sensor electrodes,
the plurality of first wiring lines have a first aggregated-lines portion, and the plurality of second wiring lines have a second aggregated-lines portion,
the first wiring lines extend to have a component of a direction orthogonal to a direction parallel to the first direction in the first aggregated-lines portion,
the second wiring lines extend to have a component of a direction orthogonal to a direction parallel to the second direction in the second aggregated-lines portion,
the second position detection unit is configured to detect a position by an electromagnetic induction system, and the second position detection unit has a plurality of first sensor coils and a plurality of second sensor coils,
each of the first sensor coils extends in the first direction, and each of the second sensor coils extends in the second direction,
each of the first sensor coils and each of the second sensor coils are disposed inside the chassis, and
at least one of the first aggregated-lines portion and the second aggregated-lines portion is disposed outside relative to the chassis when the sensor panel is viewed in plan view.
